(19) United States
(12) Patent Application Publication
(10) Pub. No.: US 2006/0129316 A1
(43) Pub. Date: Jun. 15, 2006

(54) Apparatus and method for displaying map in a navigation system

(75) Inventor: Sang-Ho Park, Anyang-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/287,786

(22) Filed: Nov. 28, 2005

(30) Foreign Application Priority Data
Dec. 14, 2004 (KR) 10-2004-0105353

(51) Int. Cl. G01C 21/32

(52) U.S. Cl. 701/211; 340/995.1

(57) ABSTRACT

A map display apparatus and method in a navigation system are provided. In the map display apparatus, a map display data storage stores display data for displaying facilities on a map and index keys specific to the display data. A Point of Interest (POI) information storage stores POI information about the facilities and display identifications (Ids) matched to the index keys, for identifying the display data of the facilities. A map display controller detects, upon selection of a POI, display data with an index key identical to the display ID of the selected POI and displays a building corresponding to the detected display data, highlighting the building.

### PRIORITY

This application claims priority under 35 U.S.C. § 119 to an application entitled “Apparatus and Method for Displaying Map in a Navigation System” filed in the Korean Intellectual Property Office on Dec. 14, 2004 and assigned Serial No. 2004-105353, the contents of which are incorporated herein by reference.

### BACKGROUND OF THE INVENTION

1. Field of the Invention

The present invention relates generally to a navigation system, and in particular, to an apparatus and method for displaying a destination on a map in a navigation system.

2. Description of the Related Art

A navigation system (or a car navigation system) notifies a user of the current position of his car and an optimum route to an intended destination, and guides him along the route. The navigation system calculates the current position of a moving object by means of a Global Positioning System (GPS) sensor and a Dead Reckoning (DR) sensor and displays map information about the path from the current position to a destination, based on stored map data.

The navigation system also displays an icon representing the destination, while displaying the map information about the path from the current position to the destination, when the moving object enters the area of the destination.

FIG. 1 illustrates an example of a conventional map display. In FIG. 1, map information about a current position to a destination is displayed three-dimensionally. Referring to FIG. 1, reference numeral 10 denotes an icon representing the position of the destination and reference numeral 100 denotes a destination building that a driver is headed for. In a conventional navigation system, the icon 10 is displayed to notify the driver of the approximate position of the destination building without pointing the destination building 100 accurately.

Therefore, the driver guesses which building is his destination from the icon 10. In the case where only one building stands near the icon 10, the driver easily recognizes the building as his destination. However, if the icon 10 is among a plurality of buildings, he has difficulty in finding his destination building. Moreover, when the destination building is not displayed precisely at the destination position, the driver cannot find the right destination building.

### SUMMARY OF THE INVENTION

An object of the present invention is to substantially solve at least the above problems and/or disadvantages and to provide at least the advantages described below. Accordingly, an object of the present invention is to provide an apparatus and method for highlighting a destination building when displaying map information in a navigation system.

Another object of the present invention is to provide an apparatus and method for accurately detecting a destination building by matching Point Of Interest (POI) information to map display data and highlighting the destination building, when displaying map information in a navigation system.

According to one aspect of the present invention, in a map display apparatus for a navigation system, a map display data storage stores display data for displaying facilities on a map and index keys specific to the display data. POI information storage stores POI information about the facilities and display identifications (Ids) matched to the index keys, for identifying the display data of the facilities. A map display controller detects, upon selection of a POI, display data with an index key identical to the display ID of the selected POI and displays a building corresponding to the detected display data, highlighting the building.

According to another aspect of the present invention, in a map display method for a navigation system, a predetermined POI corresponding to a destination is selected upon user request. The display ID of the POI is detected when displaying a map of a destination area. Display data with an index key identical to the display ID is detected and the map of the destination area is displayed, while highlighting a building corresponding to the display data on.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates an exemplary conventional map display;

FIG. 2 is a block diagram of a map display apparatus in a navigation system according to an embodiment of the present invention;

FIG. 3 illustrates a table listing Point of Interest (POI) information according to the embodiment of the present invention;

FIG. 4 illustrates a table listing polygon data according to the embodiment of the present invention;

FIG. 5 is a flowchart illustrating a map display method in the navigation system according to the embodiment of the present invention; and

FIGS. 6A and 6B illustrate examples of a map display according to the embodiment of the present invention.

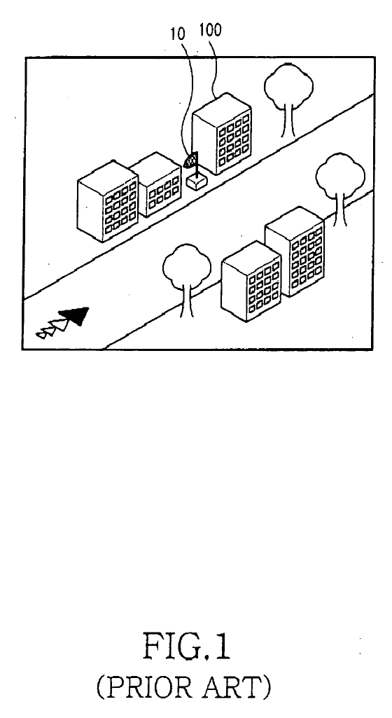

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

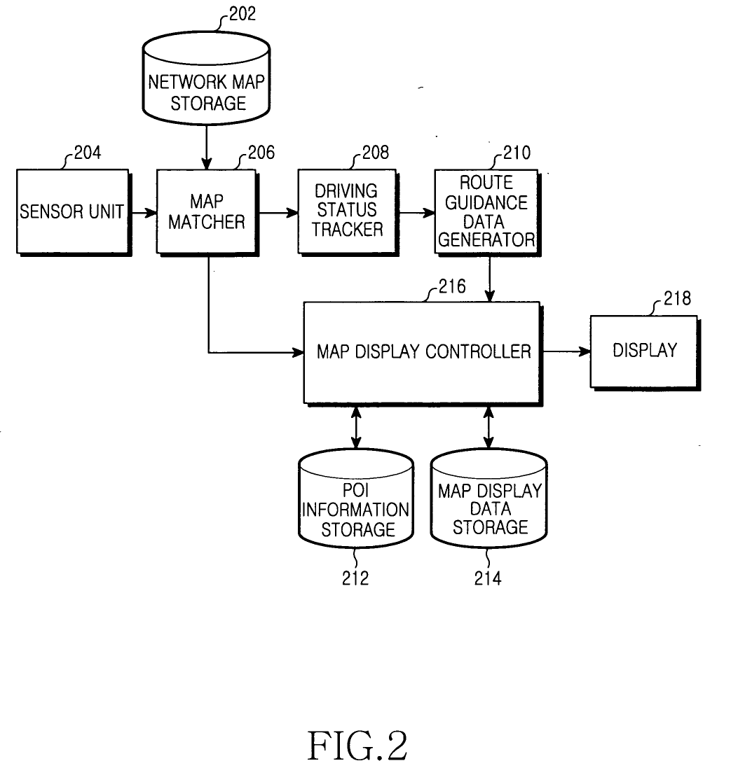

FIG. 2 is a block diagram of a map display apparatus in a navigation system according to an embodiment of the present invention. Referring to FIG. 2, the map display apparatus in the navigation system includes a network map storage 202, a sensor unit 204, a map matcher 206, a driving status tracker 208, a route guidance data generator 210, a POI information storage 212, a map display data storage 214, a map display controller 216, and a display 218.

The network map storage 202 preserves map data being preliminarily collected information of real roads, buildings, and facilities, and formed as numerical data of a predetermined format. For example, the network map storage 202 stores whole map information as digital network map data including nodes and links. A node refers to the coordinates of a specific point on a map and a link refers to a connection between nodes, like a road on the map.

The sensor unit 204 is used to measure the current position of a moving object. It includes a Global Position System (GPS) sensor and a Dead Reckoning (DR) sensor. The GPS sensor receives GPS signals and detects the position information (x, y, z) and time information (t) of the moving object. The DR sensor detects a relative position of the moving object and its heading, using previous position information. It detects the velocity (v) and angle (θ) of the moving object. The sensor unit 204 calculates the current position of the moving object based on the position and time information detected by the GPS sensor and the velocity and angle measured by the DR sensor.

The map matcher 206 performs map matching using the current position information of the moving object and the numerical network map data stored in the network map storage 202. That is, the map matcher 206 matches the current position of the moving object onto a corresponding position of the map based on the current position information of the moving object and the network map data.

The driving status tracker 208 tracks the driving status of the moving object by comparing the map matching result with a pre-calculated route to a destination. It can decide whether the moving object is off the route by comparing network map data corresponding to the map matching result with the route to the destination.

The route guidance data generator 210 generates route guidance data, using the driving status tracking result and off route information received from the driving status tracker 208, to notify the driver of the route and whether he has moved off the route.

The POI information storage 212 stores POI information and display data identifications (IDs) with respect to the POI information. POI information is defined as facility information about a particular area or a particular building on the map which is highly likely to be set as a destination by the driver. A display data ID is used to match POI information to display data for displaying a facility corresponding to the POI information.

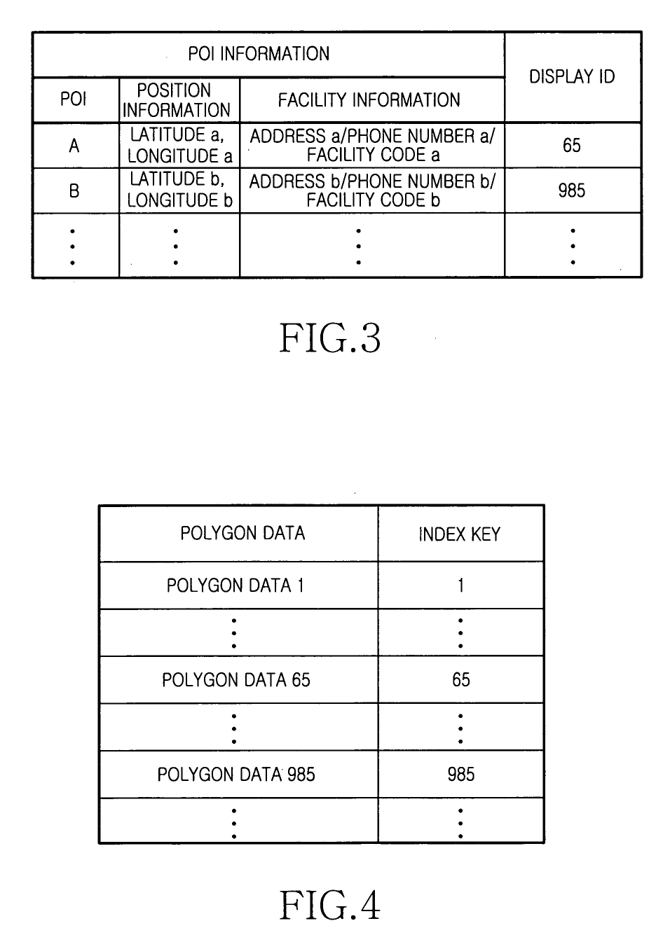

The POI information and the display data ID corresponding to the POI information are illustrated in FIG. 3. FIG. 3 illustrates an example of POI information according to the embodiment of the present invention. Referring to FIG. 3, the POI information includes position information for main facilities and facility information. The position information is the latitude and longitude coordinates of the facility. The facility information includes the address, phone number and facility code of the facility. For example, the POI information for facility A includes the latitude and longitude coordinates (latitude a, longitude a) of facility A and the facility information (address a, phone number a, facility code a) of facility A. If the facility is a building, the facility information may further include information about the number of stories in the building. A display data ID for the POI information is matched in a one-to-one correspondence to polygon data related to a building among the display data for displaying a facility corresponding to the POI information.

The map display data storage 214 stores map display data by which map information about roads, buildings, and facilities are displayed visually to the driver. In accordance with the embodiment of the present invention, the map display data includes polygon data which is vector data to display map information three-dimensionally. Each polygon data is allocated a specific index key. FIG. 4 illustrates an example of polygon data according to the embodiment of the present invention. Referring to FIG. 4, each of polygon data 1 to polygon data 985 has a specific index key ranging from 1 to 985. The polygon data are used to display three-dimensional polygonal objects, that is, a variety of facilities including buildings. An index key identifies corresponding polygon data. The index key of each polygon data is matched to the display ID of POI information.

The map display controller 216 selects a POI corresponding to the destination, upon driver request, generates a three-dimensional map for route guidance from the current position to the selected POI, and displays the map. Particularly, the map display controller 216 detects polygon data with an index key identical to the display ID of the POI and highlights a building corresponding to the detected polygon data, when displaying the three-dimensional map. The entire building or a specific floor of it can be highlighted.

A Liquid Crystal Display (LCD) can be used for the display 218. The display 218 displays the three-dimensional map with the destination building highlighted under the control of the map display controller 216.

As described above, the map display apparatus in the navigation system enables the driver to easily recognize his destination building by displaying a map with the destination building highlighted.

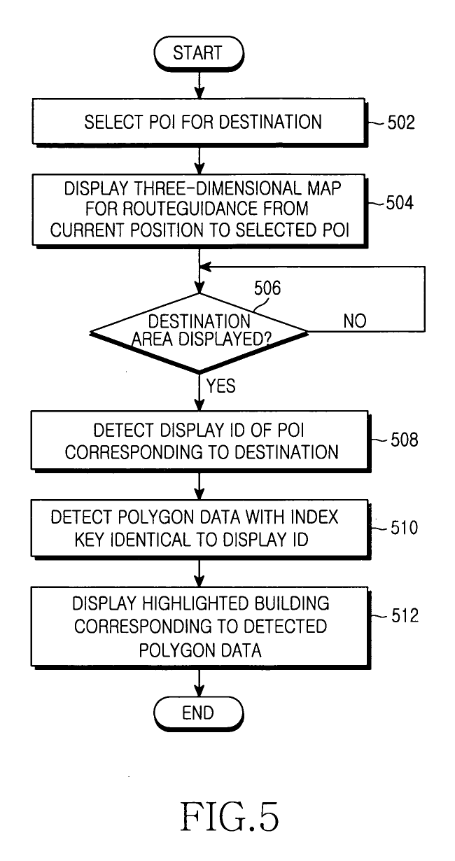

A description will now be made of a map display method in the navigation system according to the embodiment of the present invention, with reference to the flow chart of FIG.. Referring to FIG. 5, the map display apparatus selects a POI corresponding to a destination upon driver request in step 502 and generates a three-dimensional map for route guidance from a current position to the POI and displays it on the display 218 in step 504. For example, the map display apparatus generates a three-dimensional map on a predetermined area basis using an optimum route from the current position to the POI, and map display data and route guidance data for the route, for use in guiding the driver along the route.

In step 506, the map display apparatus determines whether the moving object has arrived at a destination area, that is, an area including the POI. In other words, the map display apparatus determines whether it is time to display a three-dimensional map for the destination area. It can determine whether the moving object has arrived at the POI area of the destination based on a map matching result.

If the moving object has not arrived at the destination area yet, the map display apparatus continues to perform step 504. On the other hand, if the moving object has arrived at the destination area, the map display apparatus detects a display ID corresponding to the POI in step 508, and detects polygon data with an index key identical to the display ID among polygon data stored in the map display data storage 214 in step 510. In step 512, the map display apparatus displays the map with a building corresponding to the polygon data highlighted.

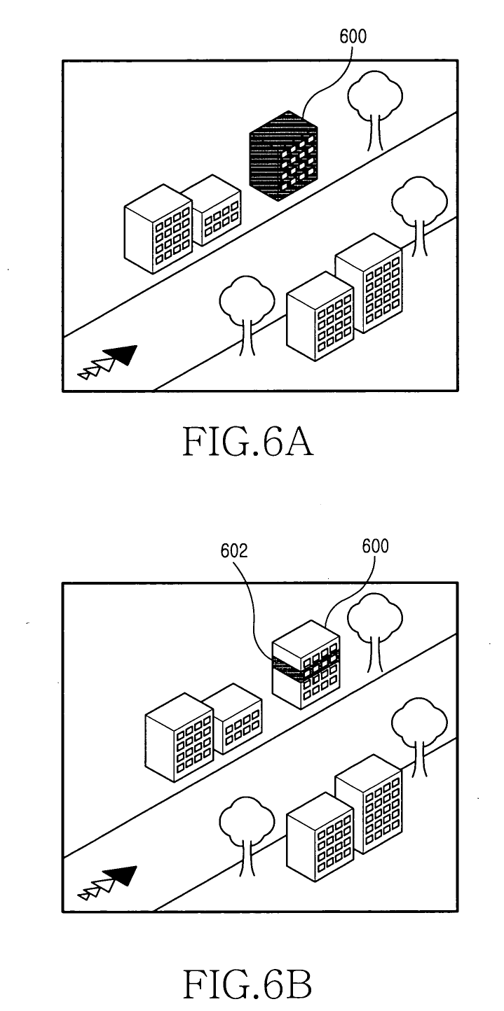

FIGS. 6A and 6B illustrate examples of a map display according to the embodiment of the present invention. Referring to FIG. 6A, the map display apparatus highlights an entire building 600 corresponding to the detected polygon data. Referring to FIG. 6B, the map display apparatus highlights a specific story 602 of the building 600. In addition, the map display apparatus can make the building conspicuous by displaying the building in a distinctive color or by any other method.

In accordance with the present invention as described above, map information is displayed so that the POI information of a destination is matched to the map display data of the destination. Therefore, an intended destination building is accurately displayed to a driver. Furthermore, highlighting the destination building in map displaying enables the driver to easily recognize the destination building.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A map display apparatus in a navigation system, comprising:
a map display data storage for storing display data for displaying facilities on a map and index keys specific to the display data;
a point of interest (POI) information storage for storing POI information about the facilities and display identifications (IDs) matched to the index keys, for identifying the display data of the facilities; and
a map display controller for, upon selection of a POI, detecting display data with an index key identical to the display ID of the selected POI and displaying a building corresponding to the detected display data.

2. The map display apparatus of claim 1, wherein the display data includes polygon data for displaying the facilities three-dimensionally.

3. The map display apparatus of claim 1, wherein the index keys of the display data are matched in a one-to-one correspondence to the display IDs of the POI information.

4. The map display apparatus of claim 1, wherein the map display controller controls the building corresponding to the detected display data to be displayed in a predetermined color, thereby differentiating the building.

5. The map display apparatus of claim 1, wherein the map display controller differentiates the building by displaying the building in a different display method from other buildings being displayed.

6. The map display apparatus of claim 1, wherein the POI information includes position information and facility information about the facilities on the map.

7. The map display apparatus of claim 6, wherein the position information of the facilities includes the latitude and longitude coordinates of the facilities.

8. The map display apparatus of claim 6, wherein the facility information of the facilities include information about the addresses, phone numbers, facility codes, and number of floors of the facilities.

9. The map display apparatus of claim 1, wherein the map display controller highlights the entire building corresponding to the detected display data.

10. The map display apparatus of claim 1, wherein the map display controller highlights a predetermined floor of the building corresponding to the detected display data.

11. A map display method in a navigation system, comprising:
selecting a predetermined point of interest (POI) corresponding to a destination upon a user request;
detecting the display identification (ID) of the POI when displaying a map of a destination area;
detecting display data with an index key identical to the display ID; and
displaying the map of the destination area, while highlighting a building corresponding to the display data.

12. The map display method of claim 11, wherein the display data includes polygon data for displaying facilities three-dimensionally on the map.

13. The map display method of claim 11, wherein the index keys of display data are matched in a one-to-one correspondence to the display IDs of POI information.

14. The map display method of claim 11, wherein the displaying step comprises the step of displaying the building corresponding to the detected display data in a different color from the color of the map of the destination area.

15. The map display method of claim 11, wherein the displaying step comprises the step of displaying the building corresponding to the detected display data in a different display method from the map of the destination area.

16. The map display method of claim 11, wherein the displaying step comprises the step of highlighting the entire building corresponding to the detected display data.

17. The map display method of claim 11, wherein the displaying step comprises the step of highlighting a predetermined floor of the building corresponding to the detected display data.
